(19) United States
(12) Patent Application Publication
(10) Pub. No.: US 2026/0178069 A1
(43) Pub. Date: Jun. 25, 2026

(54) COMBINATORIAL CLUSTERING WITH A COHERENT XY MACHINE

(71) Applicant: NTT RESEARCH, INC., Sunnyvale, CA (US)

(72) Inventors: Kyungduk KIM, Sunnyvale, VA (US); Yoshihisa Yamamoto, Sunnyvale, CA (US)

(73) Assignee: NTT RESEARCH, INC., Sunnyvale, CA (US)

(21) Appl. No.: 19/426,316

(22) Filed: Dec. 19, 2025

Related U.S. Application Data
(60) Provisional application No. 63/736,918, filed on Dec. 20, 2024.

(51) Int. Cl. G06E 1/00

(52) U.S. Cl. CPC G06E 1/00

(57) ABSTRACT

A computing system may be provided. The computing system may include a ring cavity configured to circulate optical pulses with continuously distributed phases encoding a combination of states corresponding to a current step of a combinatorial optimization. The computing system may also include a plurality of delay lines configured to implement couplings between the optical pulses to compute a next step of the combinatorial optimization.

### PRIORITY AND INCORPORATION BY REFERENCE

This application claims priority to U.S. Provisional Application No. 63/736,918 entitled “Combinatorial Clustering with a Coherent XY Machine” and filed Dec. 20, 2024, which is hereby incorporated in its entirety by reference.

### FIELD

This disclosure relates to a method of combinatorial optimization and an all-optical machine to physically implement the method of combinatorial optimization.

### BACKGROUND

Combinatorial optimization is a form of computation where a computing device searches a combination of states that minimizes a particular cost function. Such combination of states generated by combinatorial optimization may be used for clustering, a form of unsupervised machine learning with broad applications in data organization and analysis. Combinatorial clustering generally includes the computing device cycling through the different combination of states, calculating the value of the cost function for each combination, and comparing the currently calculated value against the values generated by previous combinations to determine whether the cost function is moving toward a minimum point. At the minimum point, the combination of states forms the solution of the clustering problem.

One approach to combinatorial clustering is through Quadratic Unconstrained Binary Optimization (QUBO), which encodes a clustering problem into a system of binary state Ising spins. The QUBO encoding may be implemented by coherent Ising machines to minimize the energy of the combination of Ising spins, leading to a globally minimum energy state, which forms the solution to the clustering the problem.

However, encoding a clustering problem onto binary state Ising spins (e.g., through QUBO) requires the addition of a constraint term to the cost function, which introduces numerous local minima in the energy landscape and increases the likelihood of the coherent Ising machine being trapped in a local minima, thereby leading to a suboptimal solution. Moreover, with Ising spins limited to two discrete states, escaping the local minima involves overcoming energy barriers between these binary states. These challenges degrade clustering quality and increase computational costs, particularly for larger problem sizes.

### SUMMARY

In some embodiments, a computing system may be provided. The computing system may include a ring cavity configured to circulate optical pulses with continuously distributed phases encoding a combination of states corresponding to a current step of a combinatorial optimization. The computing system may also include a plurality of delay lines configured to implement couplings between the optical pulses to compute a next step of the combinatorial optimization.

In some embodiments, a method may be provided. The method may include circulating, by a ring cavity of a computing system, optical pulses with continuously distributed phases encoding a combination of states corresponding to a current step of a combinatorial optimization. The method may also include implementing, by a plurality of delay lines of the computing system, couplings between the optical pulses to compute a next step of the combinatorial optimization.

### BRIEF DESCRIPTION OF DRAWINGS

FIG. 1 shows an illustrative coherent XY computing system, according to example embodiments of this disclosure.

FIG. 2A shows an example of clustering using the computing system, according to example embodiments of this disclosure.

FIG. 2B shows an example of clustering using the computing system, according to example embodiments of this disclosure.

FIG. 3A shows a plot with the impact of momentum on success probabilities, according to example embodiments of this disclosure.

FIG. 3B shows a plot illustrating a performance of the computing system with respect to gain of a nonlinear amplifier, according to example embodiments of this disclosure.

FIG. 3C shows a plot indicating the adjustment of saturation pulse energy Es of the nonlinear amplifier.

FIG. 4 is a flow diagram of an example method 400 for determining combinatorial optimization steps, according to example embodiments of this disclosure.

The figures are for purposes of illustrating example embodiments, but it is understood that the present disclosure is not limited to the arrangements and instrumentality shown in the drawings. In the figures, identical reference numbers identify at least generally similar elements.

### DESCRIPTION

Embodiments disclosed herein provide a method that uses XY spins instead of binary Ising spins for implementing combinatorial clustering. Unlike the binary Ising spins, which have only two states, XY spins may provide a continuous degree of freedom represented by the phase of a pulse in an optical phase space. A coherent XY computing system may leverage the continuousness of this phase space to encode a clustering problem, thereby eliminating the need for a constraint term in the cost function. The computing system may further incorporate momentum into the dynamical evolution of XY spins via self-feedback, which may help the computing system to accelerate the approach to the global minimum of the cost function and may facilitate escaping local minima.

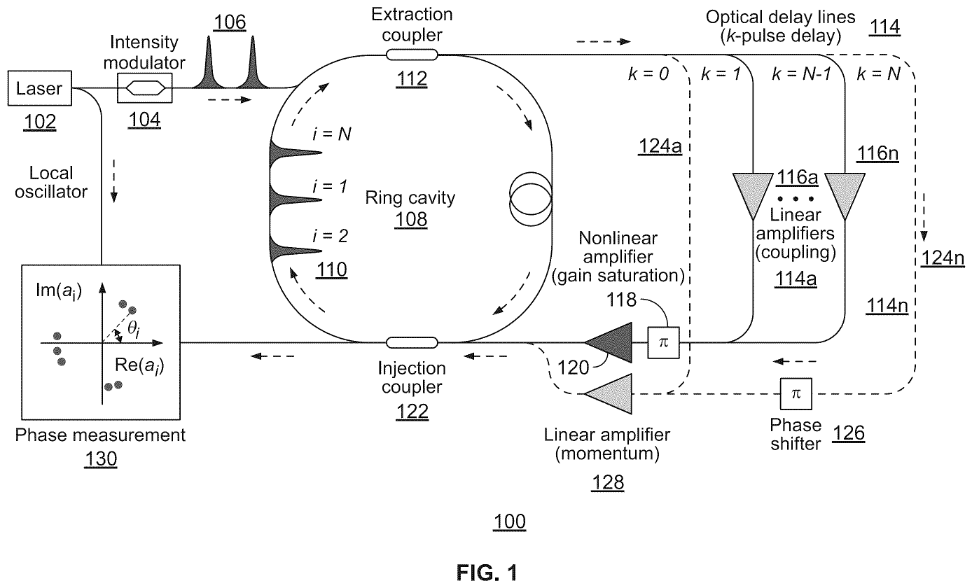

FIG. 1 shows an illustrative coherent XY computing system 100, according to example embodiments of this disclosure. The computing system 100 may include a laser emitter 102 that generates a laser emission that may pass through an intensity modulator 104. The intensity modulator 104 may modulate the intensity of the laser emission to generate pulses 106 at the same optical frequency (e.g., to maintain the coherency of radiation). The pulses 106 may enter into a ring cavity 108 and become circulating pulses 110. The circulating pulses 110 may encode each spin (i=1, . . . , N) in their corresponding field amplitudes aᵢ with complex values (e.g., containing both real and imaginary parts). An extraction coupler 112 may extract the circulating pulses 110 and feed them to the k-pulse delay lines 114a-114n (collectively k-pulse delay lines 114), thereby introducing the coupling between the circulating pulses 110. Particularly, the optical amplifiers 116a-116n (collectively optical amplifiers 116) in the k-pulse delay lines 114 (k=1, . . . , N−1) implement coupling between two spins separated by k pulses. A π-phase shifter 118 may apply repulsive coupling of the spins. The coupled spins may experience gain saturation of a nonlinear amplifier 120, and may then be reinjected back to the ring cavity 108 using an injection coupler 122. An N-pulse delay line 124n with a-phase shifter 126 and a zero-delay line 124a may introduce momentum, which may enable the computing system 100 to escape from local minima, as further described below. All of the delay lines may be referred to as optical delay lines. The magnitude of such momentum may be controlled by a linear amplifier 128. The computing system 100 may allow for a fraction of the circulating pulses 110 to be used for performing a phase measurement 130 (using a phase measurement circuitry, not shown). The phase measurement 130 may include measuring the real quadrature and the imaginary quadrature of each field amplitude aᵢ encoded by the circulating pulses 110. The phase measurements 130 may be post-processed to obtain solutions to the clustering problem.

In some embodiments, the computing system 100 may operate on the following numerical model. A clustering problem may include N data points with mutual distance dᵢⱼ between data points i and j. Each data point i may be represented by the complex-valued field amplitude aᵢ of an optical pulse (e.g., one of the circulating pulses 110 in the ring cavity 108). The circulating pulses 110 may interact with each other through a repulsive coupling constant Jᵢⱼ=−dᵢⱼ<0 (e.g., as applied by the x-phase shifter 118). The computing system 100 may involve an integer number of round trips of the circulating pulses 110 and therefore the description of the time evolution of the computing system 100 may be inherently discrete. For example, the evolution of aᵢ(t) after a cavity round trip time Δt, or a single time step, may be governed by the following difference equation:

$${a}_{i} ( t + Δ t ) = {a}_{i} ( t ) + Δ t \{ - {a}_{i} ( t ) + {e}_{i} ( t ) {\sum }_{j \neq i} {J}_{ij} {a}_{j} ( t ) + κ [ {a}_{i} ( t ) - {a}_{i} ( t - Δ t ) ] \}$$

$$where$$

$${e}_{i} ( t ) = {g [ 1 + \frac{{\vert {\sum }_{j \neq i} {J}_{ij} {a}_{j} ( t ) \vert}^{2}}{{E}_{s}} ]}^{- 1}$$

Here, eᵢ(t) may denote the gain of the nonlinear amplifier, reflecting the saturation behavior with a signal gain g and saturation pulse energy Es. The momentum parameter κ may denote a constant multiplier for aᵢ(t)−aᵢ(t−Δt), which may reflect the change in field amplitude over the preceding round trip. A classical model without considering quantum noise in optical amplifiers may be assumed.

The dynamic behavior of the above difference equation may be described as follows. The first term within the curly braces may represent a linear loss with a normalized decay rate, preventing the divergence of aᵢ over time. The summation in the second term, Σ_{j≠i}Jᵢⱼaⱼ may tend to minimize a potential V over time, where V may satisfy the equation of motion Σ_{j≠i}Jᵢⱼaⱼ=−∂V/∂aᵢ*. The potential function may be expressed as:

$$V = - 2 {\sum }_{i , j \neq i} {J}_{i j} \vert {a}_{i} \vert \vert {a}_{j} \vert cos ( {θ}_{i} - {θ}_{j} )$$

where θᵢ=tan⁻¹[Im(aᵢ)/Re(aᵢ)] may represent the phase angle of the i-th pulse, as calculated by the phase measurement 130. Assuming perfect homogeneity of field amplitudes, i.e., |aᵢ| may be equal for all i, the potential function V may be mapped to the Hamiltonian for the classical XY-spin system.

$${H}_{XY} = - {\sum }_{i , j \neq i} {J}_{ij} cos ( {θ}_{i} - {θ}_{j} )$$

Such Hamiltonian has been realized across various platforms including optical parametric oscillators, coupled lasers, polaritons, and phase modulator arrays. The physical mechanism of the computing system 100 may be rooted in this Hamiltonian where a strong repulsive coupling Jᵢⱼ may favor large phase differences |θᵢ−θⱼ| facilitating the formation of clusters with relatively weak couplings (i.e., data points having shorter mutual distances dᵢⱼ) in an optical phase space. To address amplitude inhomogeneity of the couplings Jᵢⱼ, the computing system 100 may use the nonlinear filter function eᵢ(t). The computing system 100 may implement the nonlinear filter function eᵢ(t) through the nonlinear amplifier 120. The nonlinearity imparted by the nonlinear amplifier 120 may facilitate a reduced gain for a pulse energy of the coupling field |Σ_{i,j≠i}Jᵢⱼaᵢ|² when it exceeds the saturation level Es of the nonlinear amplifier 120. Such reduced variation in energy of the coupling field may make the energy of each of the circulating pulses 110 more uniform. Therefore, the nonlinear gain may mitigate/reduce the inhomogeneity in the magnitude of each spin, and allow for the computing system 100 to adhere more closely to the XY Hamiltonian described above.

The performance of the computing system 100 may be validated by numerical simulations of combinatorial clustering. Given N data points with mutual distances dᵢⱼ, the objective of the computing system 100 may be to group these N data points into M clusters that minimize the total mutual distance within each cluster, which may also be equivalent to minimizing the cost function:

$$H = \frac{1}{2} {\sum }_{a = 1}^{M} {\sum }_{C ( i ) = a} {\sum }_{C ( j ) = a} {d}_{ij}$$

where C(i) may map the data point index i to the cluster index a, and the factor ½ may account for the double counting of an i-j pair in the summation.

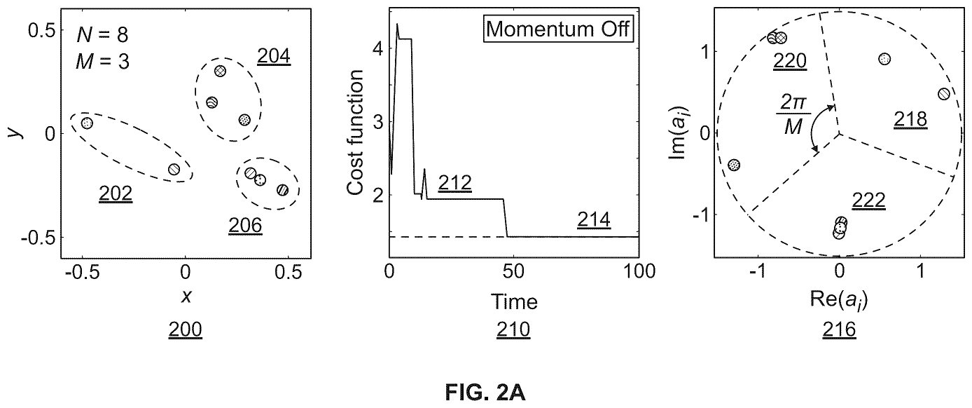

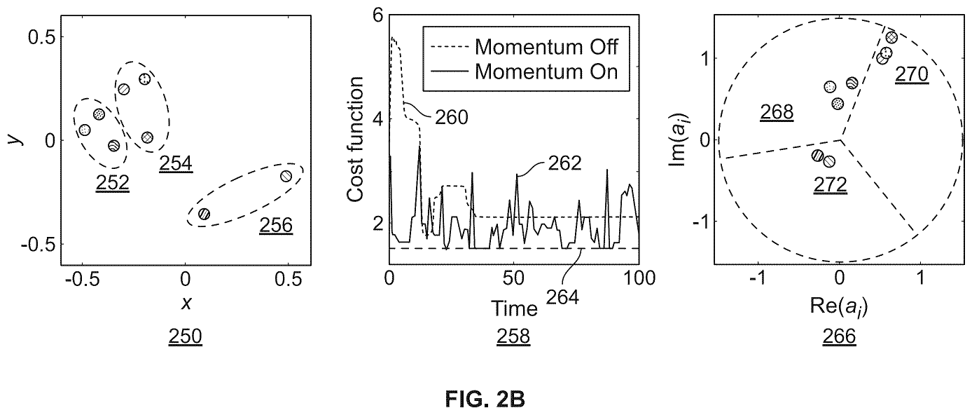

FIG. 2A shows an example of clustering using the computing system 100, according to example embodiments of this disclosure. A clustering problem is shown as distributed N=8 data points in an xy space 200 (e.g., a Euclidean space). The data points may be distributed into M=3 clusters based on the mutual Euclidean distances dᵢⱼ. The xy space 200 shows the ground state solution to be reached by the computing system 100. The ground state solution may include three clusters 202, 204, 206 for M=3.

For the simulation, the computing system 100 may be initialized at t=0 with small field amplitudes for the circulating pulses 110 with uniformly distributed random phases. The small-signal gain of the nonlinear amplifier 120 may be set to zero before t=0 and then set to a constant value of g afterward. The momentum parameter κ may be set to 0. Plot 210 shows a movement 212 of the cost function with time measured as roundtrips within the ring cavity 108 of the computing system 100. As shown, the cost function may reach the ground state 214 at 47 round trips within the ring cavity 108. Plot 216 shows field amplitudes of the N spins at the ground state within a cutting frame of 2π/M. The cutting frame 2π/M may divide the plot into 3 (i.e., M) clusters 218, 220, 222, where cluster 202 may correspond to cluster 218, cluster 204 may correspond to cluster 220, and cluster 206 may correspond to cluster 222. That is, the computing system 100 may reach the ground state 214 that corresponds to the ground state solution in the xy space 200.

FIG. 2B shows an example of clustering using the computing system 100, according to example embodiments of this disclosure. A clustering problem is shown as distributed N=8 data points in an xy space 250 (e.g., a Euclidean space). The data points may be distributed into M=3 clusters based on the mutual Euclidean distances dᵢⱼ. The xy space 250 shows the ground state solution to be reached by the computing system 100. The ground state solution may include three clusters 252, 254, 256 for M=3. This clustering problem may be more challenging because clusters 252, 254 are closer to each other.

For the simulation, the computing system 100 may be initialized at t=0 with small field amplitudes for the circulating pulses 110 with uniformly distributed random phases. The small-signal gain of the nonlinear amplifier may be set to zero before t=0 and then set to a constant value of g afterward. The momentum parameter κ may be set to 0 for a first simulation and may be set to a non-zero value for a second simulation.

Plot 258 shows a first trajectory 260 and a second trajectory 262 of the cost function with time measured as roundtrips within the ring cavity 108 of the computing system 100. The first trajectory 260 may be based on the momentum parameter κ set to 0 for the first simulation. The second trajectory 262 may be based on the momentum parameter κ set to a non-zero value. As shown, during the first trajectory 260, the cost function may not be able reach the ground state 264. However, during the second trajectory 262 with the non-zero momentum parameter κ, the cost function may reach the ground state 264 after 22 roundtrips within the ring cavity 108 of the computing system 100. The non-zero momentum parameter κ, however, may destabilize the local minima of the cost function making the second trajectory 262 of the cost function unstable over time and seemingly not being able to reach a steady state. Nevertheless, the non-zero momentum term may promote a search around the ground state 264, enabling the computing system 100 to find the global minimum. These unstable dynamics also may allow the spins to migrate freely throughout the low-energy landscape, thereby facilitating the computing system 100 to find the global minimum.

Plot 266 shows field amplitudes of the N spins at the ground state 264 within a cutting frame of 2π/M. The cutting frame 2π/M may divide the plot into 3 (i.e., M) clusters 268, 270, 272, where cluster 252 may correspond to cluster 268, cluster 254 may correspond to cluster 270, and cluster 256 may correspond to cluster 272. The computing system 100 may therefore reach the ground state 264 that corresponds to the ground state solution in the xy space 250.

In some embodiments, the computing system 100 may be further optimized through hyperparameter tuning. The tuned hyperparameters may include, for example, momentum κ, gain g of the nonlinear amplifier 120, and the saturation energy Es of the nonlinear amplifier 120. The computing system 100 may be provided with 100 clustering problem instances with N=8, M=3 and the hyperparameters may be varied to evaluate the success probability of the computing system 100 finding the ground state. For each of the 100 clustering problem instances, the computing system 100 may be started from randomly distributed phases and equal field amplitudes di. In each run, the number of cavity round trips (T) may be fixed to 20. A success probability may be defined as the proportion of successful cases out of 100 runs.

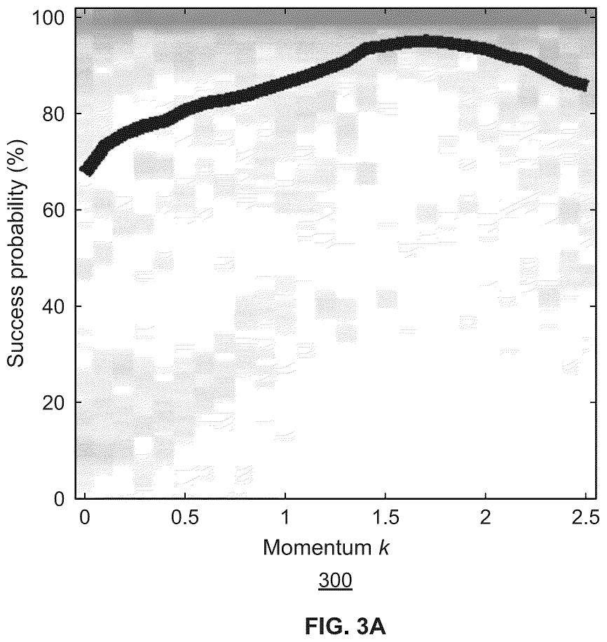

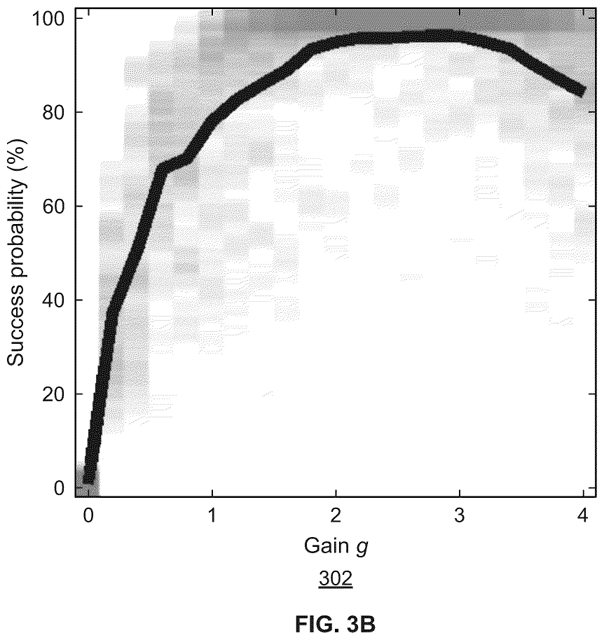

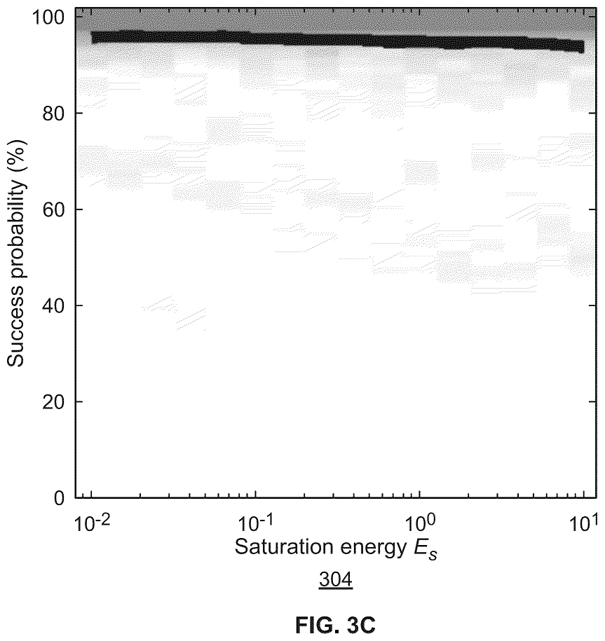

FIG. 3A shows a plot 300 with the impact of momentum κ on success probabilities, according to example embodiments of this disclosure. As shown, even at the zero momentum (κ=0), the success probability may have a peak at 68%, which may indicate efficient convergence to the ground state solution. As K increases from zero, the average success probability may further improve from 68% and may reach a peak of 95%, which may indicate that optimal momentum κ may improve the performance of the computing system 100. The minimum success probability may increase from 1% at κ=0 (not shown in the plot 300) to 37% at κ=1.7 (also not shown in the plot 300), demonstrating the role of momentum κ in tackling hard problem instances. However, success probability may drop with excessive momentum beyond κ>2 due to divergence of field amplitudes aᵢ over time.

FIG. 3B shows a plot 302 illustrating a performance of the computing system 100 with respect to gain g of the nonlinear amplifier 120, according to example embodiments of this disclosure. With a small gain g, the field amplitudes aᵢ may decay to zero, and oscillations may start to occur when g exceeds a threshold gain. Across the 100 clustering problem instances, the average oscillation threshold gain g may be found to be 1, matching the linear loss of the ring cavity 108 as shown in the dynamic equation. As shown in the plot 302, starting from nearly zero success probability at g=0, an increase in g towards the oscillation threshold may lead to a dramatic increase in success probability. It may reach a peak at g ranging from 2 to 3, just above the oscillation threshold. However, further increases in g may result in diminished success probability. This decline may be attributed to the overshoot of the field amplitudes aᵢ caused by high gain g, making the computing system 100 more susceptible to being trapped at a local minimum.

FIG. 3C shows a plot 304 indicating the adjustment of saturation pulse energy Eₛ of the nonlinear amplifier 120. The saturation may influence the energy of the circulating pulses 110 within the ring cavity 108. While a low Eₛ may reduce field amplitudes aᵢ of the circulating pulses 110, there may be no significant influences on the dynamics of corresponding phases θᵢ. Even though the Eₛ may be varied three order of magnitudes from 10 to 0.01, the average success probability may only change slightly from 95% to 96%. Therefore, the saturation pulse energy Es may not require such a fine tuning.

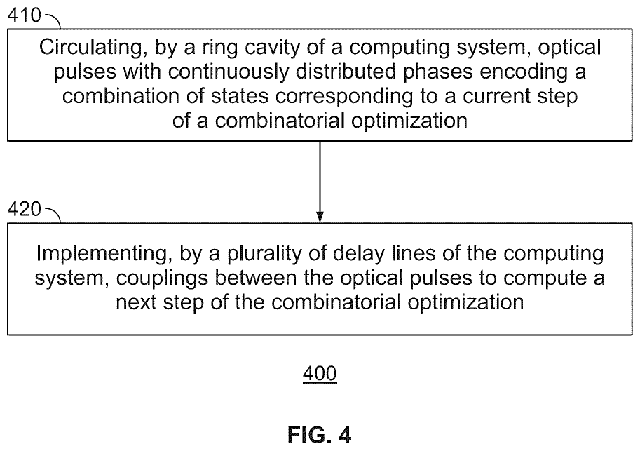

FIG. 4 is a flow diagram of an example method 400 for determining combinatorial optimization steps, according to example embodiments of this disclosure. The steps of the method 400 are merely exemplary and should no be considered limiting. In some embodiments, the method may be implemented by the computing system 100.

At step 410, the ring cavity 108 of the computing system 100 may circulate optical pulses (circulating pulses 110) with continuously distributed phases encoding a combination of states corresponding to a current step of a combinatorial optimization. Unlike the binary Ising spins, the phases may represent more than two values.

At step 420, a plurality of delay lines (k-pulse delay lines 114) of the computing system 100 may implement, couplings between the optical pulses to compute a next step of the combinatorial optimization. The couplings may be fed back to the ring cavity 108. In some embodiments, the couplings may be converted into repulsive couplings.

Additional examples of the presently described method and device embodiments are suggested according to the structures and techniques described herein. Other non-limiting examples may be configured to operate separately or can be combined in any permutation or combination with any one or more of the other examples provided above or throughout the present disclosure.

It will be appreciated by those skilled in the art that the present disclosure can be embodied in other specific forms without departing from the spirit or essential characteristics thereof. The presently disclosed embodiments are therefore considered in all respects to be illustrative and not restricted. The scope of the disclosure is indicated by the appended claims rather than the foregoing description and all changes that come within the meaning and range and equivalence thereof are intended to be embraced therein.

It should be noted that the terms “including” and “comprising” should be interpreted as meaning “including, but not limited to”. If not already set forth explicitly in the claims, the term “a” should be interpreted as “at least one” and “the”, “said”, etc. should be interpreted as “the at least one”, “said at least one”, etc. Furthermore, it is the Applicant's intent that only claims that include the express language “means for” or “step for” be interpreted under 35 U.S.C. 112(f). Claims that do not expressly include the phrase “means for” or “step for” are not to be interpreted under 35 U.S.C. 112(f).

What is claimed is:

1. A computing system comprising:
a ring cavity configured to circulate optical pulses with continuously distributed phases encoding a combination of states corresponding to a current step of a combinatorial optimization; and
a plurality of delay lines configured to implement couplings between the optical pulses to compute a next step of the combinatorial optimization.

2. The computing system of claim 1, wherein the states comprise more than two states.

3. The computing system of claim 1, further comprising:
a phase shifter configured to convert the implemented couplings to corresponding repulsive couplings.

4. The computing system of claim 1, the plurality of delay lines further comprising corresponding linear amplifiers.

5. The computing system of claim 1, further comprising:
a nonlinear amplifier connected to the plurality of delay lines and configured to reduce inhomogeneity of field amplitudes of the optical pulses.

6. The computing system of claim 1, further comprising:
an optical delay line configured to generate a momentum for computing the next step of the combinatorial optimization.

7. The computing system of claim 1, further comprising:
a phase shifter configured to generate a momentum for computing the next step of the combinatorial optimization.

8. The computing system of claim 1, wherein the optical pulses have equal or nearly equal field amplitudes.

9. The computing system of claim 1, further comprising:
a phase measurement circuitry configured to measure phases of corresponding optical pulses.

10. The computing system of claim 1, wherein the combinatorial optimization is used for an unsupervised clustering.

11. A method comprising:
circulating, by a ring cavity of a computing system, optical pulses with continuously distributed phases encoding a combination of states corresponding to a current step of a combinatorial optimization; and
implementing, by a plurality of delay lines of the computing system, couplings between the optical pulses to compute a next step of the combinatorial optimization.

12. The method of claim 11, wherein the states comprise more than two states.

13. The method of claim 11, further comprising:
converting, by a phase shifter of the computing system, the implemented couplings to corresponding repulsive couplings.

14. The method of claim 11, the plurality of delay lines further comprising corresponding linear amplifiers.

15. The method of claim 11, further comprising:
reducing, by a nonlinear amplifier connected to the plurality of delay lines, inhomogeneity of field amplitudes of the optical pulses.

16. The method of claim 11, further comprising:
generating, by an optical delay line of the computing system, a momentum for computing the next step of the combinatorial optimization.

17. The method of claim 11, further comprising:
generating, by a phase shifter of the computing system, a momentum for computing the next step of the combinatorial optimization.

18. The method of claim 11, wherein the optical pulses have equal or nearly equal field amplitudes.

19. The method of claim 11, further comprising:
measuring, by a phase measurement circuitry of the computing system, phases of corresponding optical pulses.

20. The method of claim 11, further comprising:
using the combinatorial optimization is used for an unsupervised clustering.
